(19) United States
(12) Patent Application Publication
(10) Pub. No.: US 2011/0126153 A1
(43) Pub. Date: May 26, 2011

(54) DISPLAY DEVICE AND METHOD OF CONTROLLING THE SAME

(76) Inventor: Jin-Hyo Park, Gyeonggi-do (KR)

(21) Appl. No.: 12/999,897

(22) PCT Filed: Jun. 23, 2009
(86) PCT No.: PCT/KR09/03359

§ 371 Date: Dec. 17, 2010

(30) Foreign Application Priority Data
Jun. 25, 2008 (KR) 10-2008-0060043

(51) Int. Cl. G06F 3/041; G06F 3/048

(52) U.S. Cl. 715/810; 345/173

(57) ABSTRACT

The display device according to the proposed embodiment is configured to include a screen unit that includes a display unit to display a menu image and a sensing unit to sense a user screen touch; a memory unit that stores the menu image displayed on the screen unit; and if the screen touch is sensed by the sensing unit, a controller that displays the stored menu image on the sensed touch point, wherein the controller determines directions where the menu image is to be displayed according to the sensed touch point.

### TECHNICAL FIELD

The embodiment relates to a display device, and in particular, to a display device provided with a touch screen and a control method thereof.

### BACKGROUND ART

Generally, a local key mounting unit that is able to install a plurality of local keys is disposed on a portion of a case of a display device, wherein the plurality of local keys are installed horizontally or vertically on the local key mounting unit.

As the kinds of the local keys, there is a volume key that volumes up/down volume levels, a channel key that sets up/down channel numbers, a power key that controls power operation, a menu key that executes menu, etc.

In other words, a separate local key input unit that obtains a user's operation command is provided in the display device, and the user operates the provided local key input unit to change an operation state of the display device.

The user also changes an operation state of the display device using a remote controller in addition to the local key.

If a specific key input is sensed from the user, the remote controller means a device that generates an infrared rays signal corresponding to the input key, thereby controlling TV, an air conditioner, VCR, etc.

With the recent development of electronic equipments, a remote controller has been used most of the electronic equipments and an attempt to unify a plurality of remote controllers into one in connection with a home network has been performed. The remote controller can be used in general home as well as in any places where electronic equipments can be installed.

However, when the display device is used in dark environment, there is a difficulty in changing the operation state of the display device using the local key input unit or the remote controller.

In other words, it is difficult to see the positions where the respective local keys are provided, respectively, thereby having difficulties in finding a local key corresponding to the operation state that a user wishes to change and exactly inputting it.

In the same manner, it is difficult to see the storage position of the remote controller or the positions of the respective keys, thereby causing uneasiness in changing the operation state of the display device under dark environment.

### DISCLOSURE OF INVENTION

### Technical Problem

The proposed embodiment provides a touch screen function that can easily change an operation state of a display device even under dark environment.

Further, the proposed embodiment provides a variable touch screen function corresponding to current position and state of a user by adding a tracking interface that can track touch points to the touch screen.

In addition, the proposed embodiment provides menu icons corresponding to a current position of a user, thereby providing convenience that facilitates functions requested by the user at any positions.

The technical problems achieved by the proposed embodiment are not limited to the foregoing technical problems. Other technical problems, which are not described, can clearly be understood by those skilled in the art from the following description.

### Technical Solution

A display device according to the proposed embodiment is configured to include: a screen unit that includes a display unit to display a menu image and a sensing unit to sense a user screen touch; a memory unit that stores the menu image displayed on the screen unit; and if the screen touch is sensed by the sensing unit, a controller that displays the stored menu image on the sensed touch point, wherein the controller determines directions where the menu image is to be displayed according to the sensed touch point.

Further, a method of controlling a display device according to the proposed embodiment is configured to include: sensing a screen touch; confirming a touch point where the touch is sensed; determining a display direction that a menu image is to be displayed based on the confirmed touch point; and displaying the menu image corresponding to the determined display direction on the touch point.

### Advantageous Effects

With the proposed embodiment, separate local keys are not required to be constituted in the display device, making it possible to save the space of the display device.

In addition, with the proposed embodiment, the variable menu icons are provided according to the current state of the user, making it possible to minimize touch errors that may be generated when operating the touch screen and to improve the user inconvenience and visual effects.

### BRIEF DESCRIPTION OF DRAWINGS

FIG. 1 is a diagram showing a configuration of a display device according to the proposed embodiment;

FIG. 2 is a diagram showing a menu image having left-side/right side directionalities according to the proposed embodiment;

FIG. 3 is a diagram showing a menu image having top-side/bottom-side directionalities according to the proposed embodiment;

FIG. 4 is a diagram showing space of a display device corresponding to each direction tracked by the space tracking unit 160;

FIGS. 5 to 7 are diagrams showing menu images displayed according to the proposed embodiment; and

FIGS. 8 to 11 are flowcharts showing a method of controlling a display device step by step according to the proposed embodiment.

### BEST MODE FOR CARRYING OUT THE INVENTION

The proposed embodiments will be described.

Hereinafter, the proposed embodiments will be in detail with reference to the accompanying drawings. However, the scope of the present invention is not limited the embodiments but other retrogressive inventions or other embodiments included in the scope of the present invention can be easily proposed by adding, modifying, removing, etc. of another components.

Terms used in the present invention are selected from the commonly used general terms if possible. In the specific case, the applicants can arbitrarily select terms. In this case, the meanings of the arbitrarily selected terms are described in the detailed description of the present invention. In the present invention, terms should be understood as the meanings of terms rather than a name of a simple term.

In other words, the following description, a term, “comprising” does not exclude the presence of components or steps other than ones described.

FIG. 1 is a diagram showing a configuration of a display device according to the proposed embodiment.

Referring to FIG. 1, the display device according to the proposed embodiment is configured to include a screen unit 110 that includes a memory unit 100, a display unit 120, and a sensing unit 130, a coordinate value calculating unit 140, a controller 150, and a space tracking unit 160.

The operation of the display device according to the proposed embodiment constituted as above will be described.

The memory unit 100, which is a storage device that stores various information, can be implemented by an Electrically Erasable Programmable Read Only Memory (EEPROM).

Furthermore, the memory unit 100 is preferably connected to the controller 150 to be described later according to an I2C scheme.

Herein, menu screen images according to a menu screen displayed in order to instruct commands related to various operations are stored in the memory unit 100.

More specifically, the memory unit 100 is configured to include a Read Only Memory (ROM) that stores a plurality of programs and information required in implementing the operation according to the proposed embodiment, a Random Access Memory (RAM), a voice memory, etc. Furthermore, it is noted that software that tracks the motions of a user's fingers or pointers of other input devices on a touch screen is stored in the memory unit 100.

In addition, menu images corresponding to each directionality exist in the menu image, wherein a menu image having left side directionality, a menu image having right side directionality, a menu image having top-side directionality, and a menu image having bottom-side directionality.

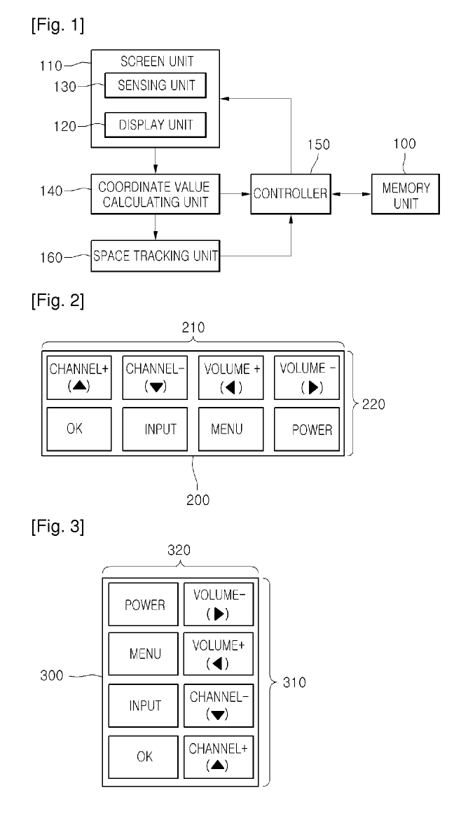

FIG. 2 is a diagram showing a menu image having left-side/right side directionalities according to the proposed embodiment, and FIG. 3 is a diagram showing a menu image having top-side/bottom-side directionalities according to the proposed embodiment.

Referring to FIG. 2, in the menu image 200 having the left-side/right side directionalities, various menu items are horizontally arranged.

Furthermore, referring to FIG. 3, in the menu image 300 having the top-side/bottom-side directionalities, various menu items are vertically arranged.

In addition, although the menu image having the left-side/right side directionalities is described to be the same and the menu image having the top-side/bottom-side directionalities is described to be the same, the menu image having the left-side/right-side/top-side/bottom-side directionalities may be implemented to be different or the menu image having the left-side/right-side/top-side/bottom-side directionalities may be implemented to be the same.

At this time, the menu image is stored in the memory unit 100 in a standard pre-calculated according to the inch of the display unit 120.

In other words, the horizontal axis standard 210 and the vertical axis standard 220 of the left-side/right side menu image 200 are formed according to a predetermined standard and then stored in the memory unit 100.

Furthermore, the standard of the menu items existing in the menu image is divided into the same size based on the horizontal axis standard 210 and the vertical axis standard 220.

In the same manner, the vertical axis standard 310 and the horizontal axis standard 320 of the top-side/bottom-side menu image 300 are formed according to a predetermined standard and then stored in the memory unit 100.

At this time, the horizontal axis standard 210 of the left-side/right side menu image 200 and the vertical axis standard of the top-side/bottom-side menu image 300 are preferably formed in the same standard. Also, the vertical axis standard 220 of the left-side/right side menu image 200 and the horizontal axis standard of the top-side/bottom-side menu image 300 are preferably formed in the same standard.

The reason why the standards of the menu images are formed in the fixed specific standard is that if a specific point is touched by the user as the menu images are displayed later, the menu items on the touched position can be easily grasped.

The screen unit 100 displays an image and senses a contact of an object approaching from the outside.

In other words, the screen unit 110 is configured to include a display unit 120 that displays an image input substantially from the outside and a sensing unit 130 that senses a contact of an object.

The display unit 120 can be applied to various types of display modules such as a digital light processing (DLP), a liquid crystal display (LCD), a plasma display panel (PDP), a light emitting diode lamp (LED), organic light emitting diodes (OLED), etc.

The sensing unit 120 senses a tapping signal from the user whose finger is contacted on the display screen, and divides and outputs a region corresponding to the position where the sensed finger is positioned. Herein, the corresponding region is to sense the user's finger and to grasp the position of the corresponding position where the user's finger is substantially contacted. Also, the sensing unit 120 is configured to include a coordinate value calculating unit 140 that calculates coordinate values of the position where the user's finger is contacted.

Herein, for the touch screen that senses the contact of the user's finger and implements the operation accordingly, there are a resistive overlay method, a capacitive overlay method, a resistive method, and an infrared beam method, etc.

In other words, the sensing 120 is a thin layer provided in the front of the display unit 110, wherein the resistive overlay method or the capacitive overlay method is used. The touch screen using the infrared beam, etc. may also be applied but preferably, the resistive overlay method or the capacitive overlay method is used.

The resistive overlay includes two layers coated with resistant material having a predetermined interval and applies current to both layers. At this time, if the both layers are contacted by applying pressure to the layers, the amount of flowing current is changed and is sensed, thereby sensing the touched position. To the contrary, the capacitive overlay coats conductive metal on both surfaces of glass and applies voltage to edges. At this time, high frequency is flowing on a touch screen and the waveform of the high frequency is changed if a user's hand is contacted, thereby sensing the position touched by sensing thereof.

The display unit 110 displays the menu images pre-stored in the memory unit 100 on the display space corresponding to the user touch point according to the sensed results of the sensing unit 120 through a display window. More preferably, the display unit 110, which accesses the menu images corresponding to the sensed results of the sensing unit 120, is connected with the controller 150 that controls the accessed menu images to be displayed in a specific display direction.

The controller 150, which is a portion to control the display as well as to control the entire operation of the display device, is a portion to change the operation state of the display device according to the sensed result of the sensing unit 120.

In other words, if the coordinate values of the point where the user's finger is touched are calculated through the coordinate value calculating unit 140 provided in the sensing unit 120, the controller 150 determines a display direction that the menu images are displayed based on the calculated coordinate values.

If the screen touch is first (first in the condition that the screen touch is not sensed for a predetermined time) sensed, the controller 150 does not perform the function corresponding to the first sensed position but displays menu images for selecting menu according to the execution of various functions.

At this time, the display direction of the displayed menu images is determined by a predetermined priority.

In other words, the user may set the priority of the display direction that the menu images are to be displayed, and the controller 150 displays the menu images in the display direction corresponding to the first ranking among display directions according to the predetermined priority.

Herein, the menu images are displayed on the display space according to the display direction determined by the controller 150, wherein the displayed menu images are menu images corresponding to the determined display direction.

Furthermore, the display point of the menu images is the coordinate point calculated by the coordinate value calculating unit 140 according to the touch of the user's finger.

In other words, the controller 150 controls the menu images corresponding to the display space to be displayed on the display space according to the determined direction, starting from the calculated coordinate point.

Herein, the controller 150 determines the display direction of the menu images according to the predetermined priority as the first ranking, and determines the display direction of the menu images according to the display space according to each directionality based on the calculated coordinate point as the second ranking.

In other words, there may be a direction that the menu images cannot be displayed according to the position of the point touched by the user.

For example, when the user touches any point of the leftmost of the display unit 110, the menu images cannot be displayed in the left side direction of the touched point. In other words, there is no display space where the menu images can be displayed in the left side direction.

However, when the display direction that is set to the first ranking is the left side direction, abnormal menu images will be displayed on the display unit 110.

Therefore, the controller 150 confirms the display directions where the menu images can be displayed according to the coordinate values of the point touched by the user, and controls the menu images corresponding to any one direction to be displayed in any one direction of the confirmed display directions.

In addition, the controller 150 grasps whether the menu images corresponding thereto can be displayed in the priority order of the set display directions, and controls the menu images to be displayed in the highest ranking display direction that the menu images can be displayed.

Therefore, the proposed embodiment is configured to include a space tracking unit 160 that grasps whether the menu images can be displayed.

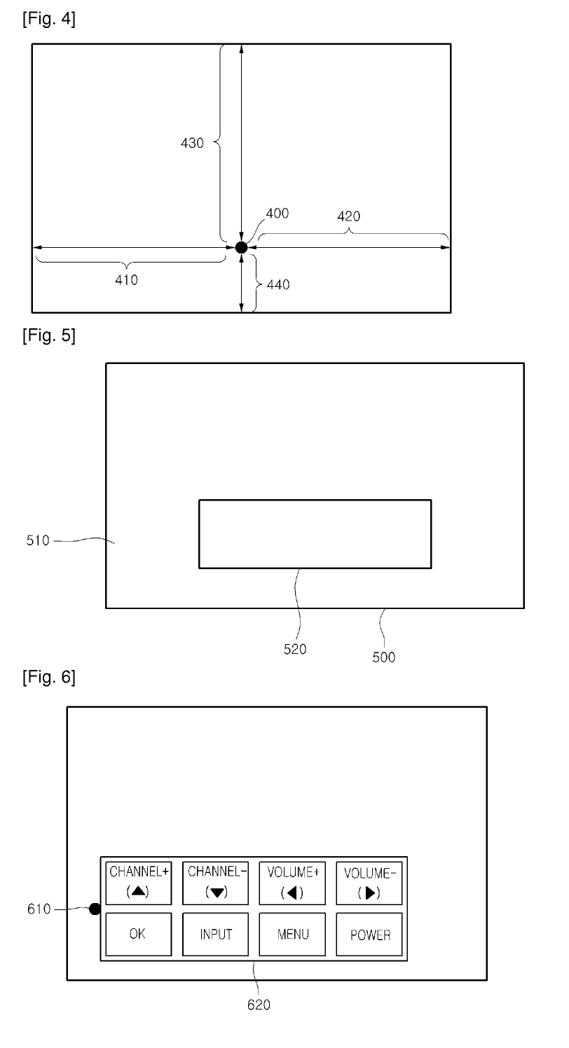

FIG. 4 is a diagram showing space of a display device corresponding to each direction tracked by the space tracking unit 160.

The space tracking unit 160 tracks a display space 410 corresponding to the left side direction, a display space 420 corresponding to the right side direction, a display space 430 corresponding to the top side direction, and a display direction 440 corresponding to the bottom side direction, based on the point 400 touched by the user, respectively.

Herein, the space tracking unit 160 can track the display spaces corresponding to the respective directions based on the calculated coordinate values and the inch information on the display unit 110.

For example, when the coordinate values according to the inch of the display unit ranges from (0,0) to (300, 200) and the calculated coordinate values are (50,50), the display space corresponding to the left side direction is 50, the display space corresponding to the right side direction is 250, the display space corresponding to the top side direction is 50, and the display space corresponding to the bottom side direction is 150.

Furthermore, the space tracking unit 160 may be configured of a sensor with a predetermined size, having X (horizontal) and Y (vertical) coordinates. In other words, the space tracking unit 160 configured of the sensor with a predetermined size is attached to the rear surface of the display unit 110, thereby observing the change of current on the contact surface. At this time, if the touch points having specific X and Y coordinate values are recognized by the coordinate value calculating unit 140, power is supplied to the right side, the left side, the top side, and the bottom side of the display unit 110, respectively, based on the recognized two coordinate values.

If the supplied power reaches the end portions of the respective directions, the display space corresponding to the respective directions can be tracked through the intensity of the reached power.

In other words, if the supplied power reaches the leftmost side based on the recognized coordinate values, the display space corresponding to the left side direction can be tracked using the power intensity at the time point where the power reaches the leftmost side. In the same manner, the display spaces corresponding thereto can be tracked using the power intensity at the time points where the power reaches in the respective directions.

The controller 150 compares the display spaces in the respective directions tracked by the space tracking unit 160 with the standards of the menu images corresponding to the respective directions, and determines the display directions of the menu images according to a result of the comparison.

Herein, for the left side and right side directions, the controller 150 compares the display space with the horizontal axis standard 210 of the menu images, and for the top side and bottom side directions, the controller 150 compares the display space with the vertical axis standard 310 of the menu images. This is the reason that in the menu image corresponding to the left side and right side directions, the respective menu items are horizontally arranged, and in the menu image corresponding to the top side and bottom side directions, the respective menu items are vertically arranged.

The controller 150 grasps the display direction having a larger display space than the standard of the menu image according to a result of the comparison, and displays the menu image corresponding thereto in a specific direction that the priority ranking is the highest among the grasped display directions.

FIGS. 5 to 7 are diagrams showing menu images displayed according to the proposed embodiment.

Referring to FIG. 5, a first screen 501 on which an image for a channel which a user is currently viewing is displayed and a second screen 502 that is output as an OSD on the first screen 501 by a screen touch of the user are shown on a display screen 500 of a display unit 110.

Menu images for changing various operation states are displayed on the second screen 502 and at this time, the display position of the second screen 502 may be variously changed according to the user touch points.

In other words, as shown in FIG. 6, when the position of the user touch point is a first point 610, the menu image can be displayed in the right side direction and the top side direction. Among others, when the priority ranking of the right side direction is higher than that of the top side direction, a menu image 620 corresponding to the right side direction of the first point 610 is displayed in the right side direction of the first point 610 on the first screen 510.

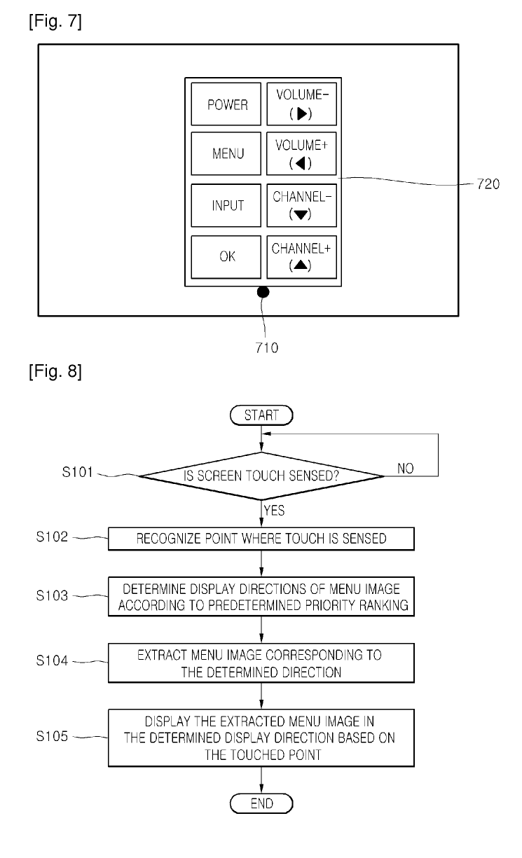

In addition, as shown in FIG. 7, when the portion of the user touch point is a second point 710, the menu image can be displayed in the left side direction and the top side direction. Among others, when the priority ranking of the top side direction is higher than that of the left side direction, a menu image 720 corresponding to the top side direction of the second point 710 is displayed in the top side direction of the second point 710 on the first screen 510.

Furthermore, if the touch of the original user' finger is sensed, the controller 150 graphs a current power state. If the grasped current power state is a turn-off state, the controller 150 changes the power state into a turn-on state.

In other words, there is no environment but for turning on power when the touch of the user's finger is sensed in a state where the power is turned off, such that the controller 150 only changes the power state instead of displaying separate menu images as described above.

As described above, the display device according to the proposed embodiment is not required to be provided with separate local keys, making it possible to save space of the display panel accordingly. Furthermore, the variable menu image according to the position of the original user touch is provided instead of the fixed menu image, making it possible to minimize the user touch errors and to improve the user convenience and the visual effects.

FIG. 8 is a flowchart showing a method of controlling a display device step by step according to the proposed embodiment.

Referring to FIG. 8, in the method of controlling the display device according to the proposed embodiment, first, it is determined whether a screen touch from the outside is sensed (S101).

Continuously, if the screen touch is sensed as a result of the determination (S101), a point where the touch is sensed is recognized (S102).

Display directions to display the menu image according to the predetermined priority ranking are determined (S103). In other words, a specific direction whose priority ranking is set to a first ranking, among a left side direction, a right side direction, a top side direction, and a bottom side direction, is determined as a display direction that the menu image is to be displayed.

Continuously, a menu image corresponding to the determined display direction is extracted (S104).

Then, the extracted menu image is displayed on the display space corresponding to the determined display direction based on the touched point (S105).

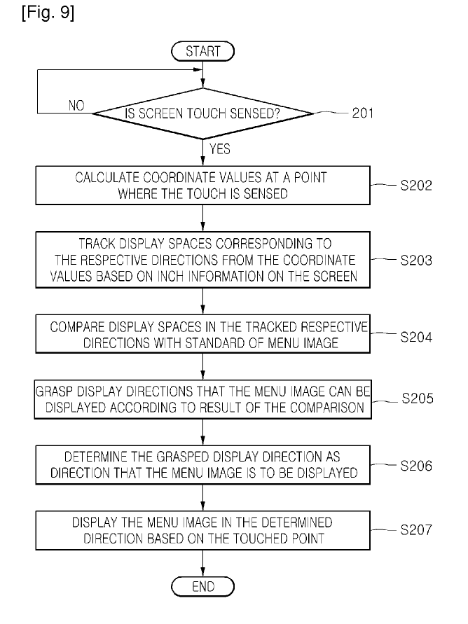

FIG. 9 is a flowchart showing a method of controlling a display device step by step according to proposed another embodiment.

First, it is determined whether a screen touch from the outside is sensed (S201).

Continuously, if the screen touch is sensed as a result of the determination (S201), a point where the touch is sensed is recognized (S202). In other words, coordinate values of the point where the touch is sensed are calculated.

Continuously, display spaces corresponding to the respective directionalities are tracked from the coordinate values based on the inch information on the screen (S203). In other words, the display space corresponding to the left side direction, the display space corresponding to the right side direction, the display space corresponding to the top side direction, and the display space corresponding to the bottom side direction, based on the coordinate values, are tracked, respectively.

The display spaces corresponding to the tracked respective directions are compared with the standard of the menu image (S204).

Continuously, the display direction that the menu image can be displayed is grasped according to a result of the comparison (S205). In other words, the direction having a larger display space than the standard of the menu image is grasped.

The display direction having the highest priority ranking among the grasped display directions is determined as a display direction that the menu image is to be displayed (S206).

Continuously, the menu image corresponding to the determined display direction is displayed in the determined display direction based on the touched point (S207).

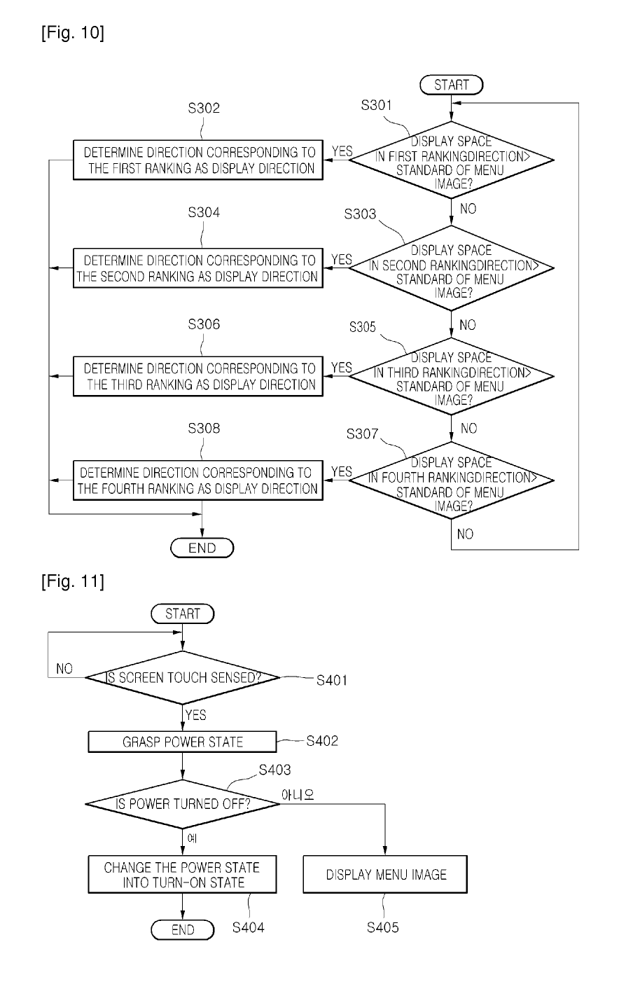

FIG. 10 is a detailed flowchart for steps 5204 to 5206 of FIG. 9.

Referring to FIG. 10, first, the display space corresponding to the display direction set to the first ranking is compared with the standard of the menu image corresponding to the display direction, thereby determining whether the display space is larger than the standard of the menu image (S301).

Continuously, as a result of the determination (S301), if the display space is larger than the standard of the menu image, a direction corresponding to the first ranking is determined as a display direction of the menu image (S302).

Furthermore, as a result of the determination (S302), if the display space is smaller than the standard of the menu image, a display space corresponding to the display direction set to a second ranking is compared with the standard of the menu image corresponding to the display direction, thereby determining whether the display space is larger than the standard of the menu image (S303).

Continuously, as a result of the determination (S303), if the display space is larger than the standard of the menu image, the direction corresponding to the second ranking is determined as a display direction of the menu image (S304).

In addition, as a result of the determination (S303), if the display space is smaller than the standard of the menu image, a display space corresponding to the display direction set to a third ranking is compared with the standard of the menu image corresponding to the display direction, thereby determining whether the display space is larger than the standard of the menu image (S305).

Continuously, as a result of the determination (S305), if the display space is larger than the standard of the menu image, the direction corresponding to the third ranking is determined as a display direction of the menu image (S306).

In addition, as a result of the determination (S305), if the display space is smaller than the standard of the menu image, a display space corresponding to the display direction set to a fourth ranking is compared with the standard of the menu image corresponding to the display direction, thereby determining whether the display space is larger than the standard of the menu image (S307).

Continuously, as a result of the determination (S307), if the display space is larger than the standard of the menu image, the direction corresponding to the fourth ranking is determined as a display direction of the menu image (S308).

FIG. 11 is a flowchart showing a method of controlling a display device step by step according to proposed another embodiment.

First, it is determined whether a screen touch from the outside is sensed (S401).

Continuously, if the screen touch is sensed as a result of the determination (S401), a current power state is grasped (S402).

It is determined whether the grasped power state is a turn-off state (S403).

Continuously, as a result of the determination (S403), if the grasped power state is a turn-off state, the power state is changed into a turn-on state (S404).

In addition, as a result of the determination (S403), if the grasped power state is a turn-on state, the menu image is displayed on the touched point (S405).

As described above, the display device according to the proposed embodiment is not required to be provided with separate local keys, making it possible to save space of the display panel accordingly. Furthermore, the variable menu image according to the position of the original user touch is provided instead of the fixed menu image, making it possible to minimize the user touch errors and to improve the user convenience and the visual effects.

### INDUSTRIAL APPLICABILITY

The present invention can be easily performed in all display devices, having industrial applicability.

1. A display device, comprising:
a screen unit that includes a display unit to display a menu image and a sensing unit to sense a user screen touch;
a memory unit that stores the menu image displayed on the screen unit; and
if the screen touch is sensed by the sensing unit, a controller that displays the stored menu image on the sensed touch point,
wherein the controller determines directions where the menu image is to be displayed according to the sensed touch point.

2. The display device according to claim 1, wherein the memory unit is stored with the respective menu images having left side, right side, top side and bottom side directionalities.

3. The display device according to claim 1, further comprising:
if the screen touch is sensed by the sensing unit, a coordinate value calculating unit that calculates coordinate values of the position where the screen touch is sensed,
wherein the controller displays a menu image having any one directionality of the left side, right side, top side and bottom side directionalities on a point corresponding to the calculated coordinate values.

4. The display device according to claim 3, wherein the controller determines a direction of the menu image to be displayed according to a predetermined priority ranking.

5. The display device according to claim 3, further comprising:
a space tracking unit that tracks display spaces for the respective display directions from the calculated coordinate values based on inch information on the screen unit.

6. The display device according to claim 5, wherein the controller determines any one of display directions having a larger display space than the standard of the menu image as a direction that the menu image is to be displayed, and the menu image is displayed on the display space corresponding to the determined display direction.

7. The display device according to claim 6, wherein the menu image to be displayed is a menu image having a directionality corresponding to the determined display direction.

8. The display device according to claim 1, wherein if a power state at the time point where the screen touch is sensed is a turn-off state, the controller changes the turn-off state into a turn-on state.

9. A method of controlling a display device, comprising:
sensing a screen touch;
confirming a touch point where the touch is sensed;
determining a display direction that a menu image is to be displayed based on the confirmed touch point; and
displaying the menu image corresponding to the determined display direction on the touch point.

10. The method of controlling the display device according to claim 9, wherein the confirming the touch point comprises calculating coordinate values according to a position where the touch is sensed.

11. The method of controlling the display device according to claim 9, further comprising:
storing menu images having top side, bottom side, left side and right side directionalities,
wherein the menu images are formed in the same standard.

12. The method of controlling the display device according to claim 9, wherein the determining the display direction comprises determining a display direction corresponding to a first ranking according to a predetermined priority ranking as a direction that the menu image is displayed.

13. The method of controlling the display device according to claim 12, further comprising:
tracking display spaces corresponding to the respective display directions from the confirmed touch point based on inch information on the display device.

14. The method of controlling the display device according to claim 13, further comprising:
re-determining the determined display direction based on the display spaces corresponding to the tracked respective display directions.

15. The method of controlling the display device according to claim 14, wherein the re-determining the determined display direction includes:
comparing the display space corresponding to the determined display direction with the standard of the menu image; and
when the standard of the menu image is larger than the display space as a result of the comparison, changing the determined display direction.

16. The method of controlling the display device according to claim 15, wherein the changing the determined display direction includes:
comparing display spaces of display directions other than the determined display direction with the standard of the menu image;
confirming display directions that the display spaces are larger than the standard of the menu image as a result of the comparison; and
determining a display direction whose priority ranking is the highest among the confirmed display directions as a direction that the menu image is displayed.

17. The method of controlling the display device according to claim 11, wherein the displaying the menu image includes:
extracting a menu image corresponding to the determined display direction; and
displaying the extracted menu image on a display space corresponding to the display direction.

18. The method of controlling the display device according to claim 9, further comprising:
grasping a power state at a time point where the touch is sensed; and
if the grasped power state is a turn-off state, changing the power state into a turn-on state.
